(19) United States
(12) Patent Application Publication
(10) Pub. No.: US 2020/0344112 A1
(43) Pub. Date: Oct. 29, 2020

(54) ON-PREMISE AND OFF-PREMISE DEBUGGING

(71) Applicant: International Business Machines Corporation, Armonk, NY (US)

(72) Inventors: John Anthony Reeve, Winchester (GB); Robert Convery, Fair Oak (GB)

(21) Appl. No.: 16/801,268

(22) Filed: Feb. 26, 2020

(30) Foreign Application Priority Data
Apr. 26, 2019 (GB) 1905835.3

(51) Int. Cl. H04L 12/24; H04L 29/06; H04L 29/08; H04L 12/46

(52) U.S. Cl. CPC H04L 41/0631; H04L 12/4633; H04L 67/141; H04L 63/029

(57) ABSTRACT

A computer-implemented method, computer program product, and computer system are provided to: (i) receive, via a first communication component of a connectivity component, a debug request from an on-premise server; (ii) identify, at the connectivity component, a debug port of an off-premise server based on the received debug port request; and (iii) communicate, via a second communication component of the connectivity component, the debug request to the identified debug port of the off-premise server.

### BACKGROUND

The present invention relates generally to debugging, and more particularly to debugging across off-premise and on-premise platforms.

Communication between on-premise and off-premise platforms is required in Software as a Service (SaaS) environments and hybrid integration systems. SaaS is a software licensing and delivery model in which software is licensed on a subscription basis and is centrally hosted by an off-premise platform (such as a shared computing resource or a cloud computing resource accessible via the Internet for example). SaaS is typically accessed by users of an on-premise platform (for example, using a thin client via a web browser). Hybrid integration systems deploy parts of the integration in an off-premise platform and other parts in an on-premise platform.

On-premise platforms are well-established and considered to provide a good level of security because data is stored and handled internally, e.g., within an internal private network. Off-premise platforms (such as cloud computing resources) are a relatively recent and evolving concept. Generally, reference to off-premise resources or platforms is taken to refer to a concept for enabling ubiquitous, convenient, and on-demand access via Internet to shared pools of configurable off-premise (e.g. remotely located) computing resources such as networks, applications, servers, storages, applications, functionalities, and the like. Conversely, reference to on-premise resources or platforms is taken to refer to a concept of local or private computing resources such as networks, servers, storage devices, application, etc. that are situated locally or within/behind a virtual boundary (often behind a firewall).

Debugging and fault analysis of such systems hosted across on-premise and off-premise platforms can be difficult and complex, for example, because there can be several parts to one integration flow that reside both off-premise (e.g. in cloud computing resources) and on-premise. Debugging separate parts across on-premise and off-premise platforms may require a user to set up access between several systems. Some of these systems may be available on the public Internet, and may need to be secured, and others may be available on private networks, and may not be accessible to all.

### SUMMARY

According to an aspect of the present invention, there is a computer-implemented method, computer program product, and computer system for managing debugging across off-premise and on-premise servers. The method comprises receiving, via a first communication component of a connectivity component, a debug request from an on-premise server. The method also comprises identifying, at the connectivity component, a debug port of an off-premise server based on the received debug port request. The method further comprises communicating, via a second communication component of the connectivity component, the debug request to the identified debug port of the off-premise server.

### BRIEF DESCRIPTION OF THE DRAWINGS

FIG. 1 is a block diagram of an exemplary implementation of a hybrid cloud system, according to an embodiment of the present invention;

FIG. 2 is a block diagram of a hybrid cloud system comprising a connectivity component, according to an embodiment of the present invention;

FIG. 3 depicts an example of the embodiment of FIG. 2, wherein an on-premise graphical debugger is debugging integrations of the on-premise sever and the off-premise server;

FIG. 4 depicts a flow diagram of a method for managing debugging across off-premise and on-premise servers, according to an embodiment of the present invention;

FIG. 5 illustrates a cloud system node, according to an embodiment of the present invention;

FIG. 6 illustrates a cloud computing environment, according to an embodiment of the present invention; and

FIG. 7 illustrates cloud abstraction mode layers, according to an embodiment of the present invention.

### DETAILED DESCRIPTION

Embodiments of the present invention seek to provide a connectivity component for managing debugging between off-premise and on-premise servers, thus enabling several dislocated components of a system to be debugging via one local component for example.

Embodiments of the present invention also seek to provide a computer-implemented method of managing debugging across off-premise and on-premise servers. Embodiments of the present invention further seek to provide a computer program product including computer program code for implementing the proposed concepts when executed on a processor. Embodiments of the present invention yet further seek to provide a system adapted to execute this computer program code.

According to an embodiment of the present invention, there is provided a connectivity component adapted to manage debugging across off-premise and on-premise servers. The connectivity component comprises a first communication component adapted to receive a debug request from an on-premise server. The connectivity component also comprises a routing component adapted to identify a debug port of an off-premise server based on the received debug port request. A second communication component of the connectivity component is adapted to communicate the debug request to the identified debug port of the off-premise server.

Proposed is a concept of communicating debug requests between off-premise and on-premise sites/resources. This may allow a debug port of an off-premise (e.g. cloud) server to be exposed via a connectivity component, thus enabling the debug port to be connected to via an on-site (e.g. local) server. A cloud-based service may then be debugged using a local integration server in the same as for any other local application.

For example, proposed embodiments may provide a concept that facilitates the exposure of debug ports of all integration servers in a hybrid cloud integration system (including those of remote servers running in the cloud) via an on-premise (e.g. local) integration server. The on-premise integration server may thus gain access to a set of debug ports that an on-premise graphical debugger application can then connect to and be used to debug all integration servers in the hybrid system.

The proposed approach for exposing the remote (i.e. off-premise) debug ports is to employ a port forwarding capability of a connectivity component. Such a connectivity component may dynamically configure itself based on severs starting and stopping, for example.

Embodiments may provide a user with the impression that he/she is his/her local (i.e. on-premise) integration server, although he/she will in fact be debugging all enabled servers (including off-premise servers). This may allow for debugging integrations that consist of flows in more than one integration server and that are not collocated.

Thus, proposed embodiments may enable a user to connect to local integration server of a hybrid integration system yet enable the user to debug the entire hybrid integration system (including off-premise integration servers of the hybrid integration system).

Such embodiments may be facilitated by providing a connectivity component with a port-forwarding capability. Use of connectivity component in this manner may require minimal user setup and may also be secure. Further, such a connectivity component may be implemented in conjunction with pre-existing switch technology that facilitate reverse proxying and dynamic registering concepts.

A connectivity component, such as a switch component, is thus proposed which may manage debugging communication between the off-premise and on-premise systems by receiving a debug request from an on-premise server and then communicating the request to an off-premise server based on identified debug port data. Such debug port data may be identified by the connectivity component using a data store which is adapted to store debug port data associated with off-premise servers.

Proposed embodiments may avoid exposure of debug ports to public networks and may thus prevent or hinder the sensitive, confidential or valuable information from being compromised via a public network. For instance, connection from the off-premise server to the connectivity component and to the on-premise server may be secured (e.g. using HTTPS) to prevent other applications from being able to access the end systems.

Proposed concepts may allow local (i.e. on-premise) debugging of applications/systems which are configured to run either in the off-premise (e.g. cloud) environment, or the on-premise environment. For example, the applications/system may be separated such that the ones which require access to on-premise systems of record run in the on-premise servers, and ones that would benefit from off-loading their computationally intensive processing run in the off-premise infrastructure. A connectivity component, such as a switch component, is thus proposed which may manage debugging communication between the off-premise and on-premise systems by receiving a debug request from an on-premise server and then communicating the request to an off-premise server based on identified debug port(s). Such debug port(s) may be identified by the connectivity component using a data store which is adapted to store debug port data associated with off-premise applications.

Proposed concepts may facilitate mapping of debug ports between an off-premise system (e.g. SaaS environment) and an on-premise system. Also, proposed embodiments may avoid the exposure of debug ports and private or sensitive debugging information at the off-premise platform (e.g. via a public network).

In some environments, the first communication component of the connectivity component may be adapted to establish a secure tunnel for receiving the debug request. Similarly, the second communication component may be adapted to establish a secure tunnel for communicating the debug request. For example, a mutually authenticated TLS tunnel connection may be to transfer data between the two environments. Secure debugging communications between off-premise and on-premise platforms may therefore be provided.

By way of example, the debug request may comprise at least one of: an application name; a server identification; a server address; an application version identifier; permission information; entry point data, and/or checksum information. Such information may then be used to match a debug request to an off-premise server.

In an embodiment, the connectivity component may further comprise a registration module adapted to receive debug port data from at least one of: an application of an off-premise server; an application of an on-premise server; an off-premise server module; and/or an on-premise server module. The registration module may then be adapted to store received debug port data in a data store. Embodiments may therefore employ the concept of registering information about accessing or making use of off-premise debug ports with the connectivity component so that the connectivity component can identify how to handle (e.g. where to communicate) a debug request. By using such a registration concept, a data store of debug port data may be dynamically updated or maintained to reflect changes in available applications or severs.

For example, the registration module may be adapted to remove debug port data from the data store in response to at least one of: an application; a server; and/or a debug port becoming inaccessible (e.g. being disconnected, terminated, or powered-down). Proposed concepts may therefore be thought of as providing a dynamically updated store of debug port information representing off-premise debug ports that may be accessible, and how the debug ports are accessible (e.g. port identification, server location/address, supported applications, etc.). Embodiments may therefore provide a connectivity component which can adapt to implementation specifics and cater for changes in off-premise servers, thereby providing a high degree of flexibility and adaptability.

In an embodiment, the off-premise server may comprise a cloud sever, and the debug request may be provided by a debugging service of the on-premise server. Embodiments may therefore be employed in a hybrid system or SaaS environment for the provision of cloud-based services over the internet for example.

In embodiments, the second communication component may be adapted to receive a response to the debug request from the off-premise server. Also, the first communication component may be adapted to communicate the received response to the on-premise server. In this way, a response to a debug request may be communicated back to the on-premise originator of the debug request.

By way of further description and example, the debug request may be sent over the port forwarded connection (via the connectivity component) to the off-premise server and that connection may then remain open while an application of the off-premise server is being debugged. In this way, the port-forwarded connection enables data to be sent in both directions without the connection being closed (until debugging is finished). For instance, exemplary process steps implemented by an embodiment comprise: (i) establish a connection to the off-premise server via the connectivity component using port forwarding and dynamically-registered debug port data (e.g. off-premise server detail); (ii) communicate the debug request to the identified debug port of the off-premise server to set break points over the connection; and (iii) the off-premise server then sends data back to the debugger, over the same, long lived, connection, when break points are hit.

Proposed connectivity components may therefore provide for the management of debugging communication between off-premise and on-premise platforms so that requests and responses are appropriately delivered whilst avoiding exposure via one or more public networks.

Embodiments may be employed in a switch module. For example, there may be provided a switch module comprising a connectivity component according to a proposed embodiment. Also, embodiments may be implemented in a server device. Such a server device may be a cloud-based server resource accessible via the Internet.

According to another aspect, there is provided a computer-implemented method of managing debugging across off-premise and on-premise servers. The method comprises receiving, via a first communication component of a connectivity component, a debug request from an on-premise server. The method also comprises identifying, at the connectivity component, a debug port of an off-premise server based on the received debug port request. The method further comprises communicating, via a second communication component of the connectivity component, the debug request to the identified debug port of the off-premise server.

According to another embodiment of the present invention, there is provided a computer program product for managing debugging across off-premise and on-premise servers, the computer program product comprising a computer readable storage medium having program instructions embodied therewith, the program instructions executable by a processing unit to cause the processing unit to perform a method according to one or more proposed embodiments when executed on at least one processor of a data processing system.

According to yet another aspect, there is provided a processing system comprising at least one processor and the computer program product according to one or more embodiments, wherein the at least one processor is adapted to execute the computer program code of said computer program product.

The processing system may be adapted to act as a switching or connectivity component between an on-premise server and an off-premise server. The processing system may be adapted to implement a part of an off-premise platform, such as a cloud-based system or server. Thus, there may be proposed a system which evaluates a debug request and determines where to communicate the request based on stored data associated with applications. Taking such an approach may enable dynamic and secure debugging access between on-premise and off-premise platforms, thus enabling debug ports of an off-premise server to be accessible via an on-premise server.

It should be understood that the Figures are merely schematic and are not drawn to scale. It should also be understood that the same reference numerals are used throughout the FIGS. to indicate the same or similar parts.

In the context of the present application, where embodiments of the present invention constitute a method, it should be understood that such a method is a process for execution by a computer, i.e. is a computer-implementable method. The various steps of the method therefore reflect various parts of a computer program, e.g. various parts of one or more algorithms.

Also, in the context of the present application, a (processing) system may be a single device or a collection of distributed devices that are adapted to execute one or more embodiments of the methods of the present invention. For instance, a system may be a personal computer (PC), a server or a collection of PCs and/or servers connected via a network such as a local area network, the Internet and so on to cooperatively execute at least one embodiment of the methods of the present invention.

An “application” may be understood as being a processing resource, routine, set of instructions, data system, or processing construct which may be provided in a structured or ordered manner. Thus, when employed for integration between off-premise and on-premise resources (such as may be done in cloud-based provision of software to a user of an on-premise resource, or as part of a SaaS environment), one or more of the instructions, routines or processes of an application may be accessed by an external system, thus requiring communication between the off-premise and on-premise resources.

Embodiments of the present invention propose concepts for establishing and/or managing debugging communication between off-premise and on-premise platforms, wherein the data processing applications may be split or separated into applications which can be implemented in the off-premise environment or in the on-premise environment, and wherein the applications may invoke each other and exchange data via a connectivity component (e.g. a switching module). A connectivity component may thus be implemented to receive a debug request and forward such a request to the appropriate destination (e.g. debug port), wherein the appropriate debug port is determined based on the debug request and/or a data store comprising information about debug ports of off-premise servers. The connectivity component may thus enable a port-forwarded connection to be established with an off-premise server, and the connection may then remain open while an application of the off-premise server is being debugged.

Embodiments may therefore propose a concept of port forwarding from an off-premise server to an on-premise server, via a connectivity component. In this way, all debug ports for all integration servers in a user's system (including remote servers running in the cloud) may be exposed (i.e. accessible) via an on-premise (i.e. local) integration server.

Illustrative embodiments may therefore provide concepts for establishing a port-forwarded connection between off-premise resources and on-premise resources and for securely communicating debugging information between the off-premise resources and on-premise resources via said connection. Secure and dynamic distributed debugging of off-premise resources via an on-premise resource may therefore be provided by proposed embodiments. Modifications and additional steps to a traditional SaaS implementation may also be proposed which may enhance the value and utility of the proposed concepts.

Illustrative embodiments may be utilized in many different types of distributed processing environments. In order to provide a context for the description of elements and functionality of the illustrative embodiments, the figures are provided hereafter as an example environment in which aspects of the illustrative embodiments may be implemented. It should be appreciated that the figures are only exemplary and not intended to assert or imply any limitation with regard to the environments in which aspects or embodiments of the present invention may be implemented. Many modifications to the depicted environments may be made without departing from the spirit and scope of the present invention. Moreover, the system may take the form of any of a number of different processing devices including client computing devices, server computing devices, a tablet computer, laptop computer, telephone or other communication devices, personal digital assistants (PDAs), or the like. In some illustrative examples, an off-premise device and an on-premise device may comprise a portable computing device that is configured with flash memory to provide non-volatile memory for storing operating system files and/or user-generated data, for example. Thus, the system may essentially be any known or later-developed processing system without architectural limitation.

A proposed concept may enhance a hybrid cloud system by providing a component or method that exposes the debug ports for all servers (including remote servers running in the cloud) via a local (i.e. on premise) server.

Embodiments may enable an on-premise server to expose a set of debug ports that a graphical debugger can connect to and then debug all servers in the hybrid cloud system.

P201901470US01 Page 12 of 37

Such proposals can extend or improve the debugging capabilities, security and/or efficiency of hybrid cloud system.

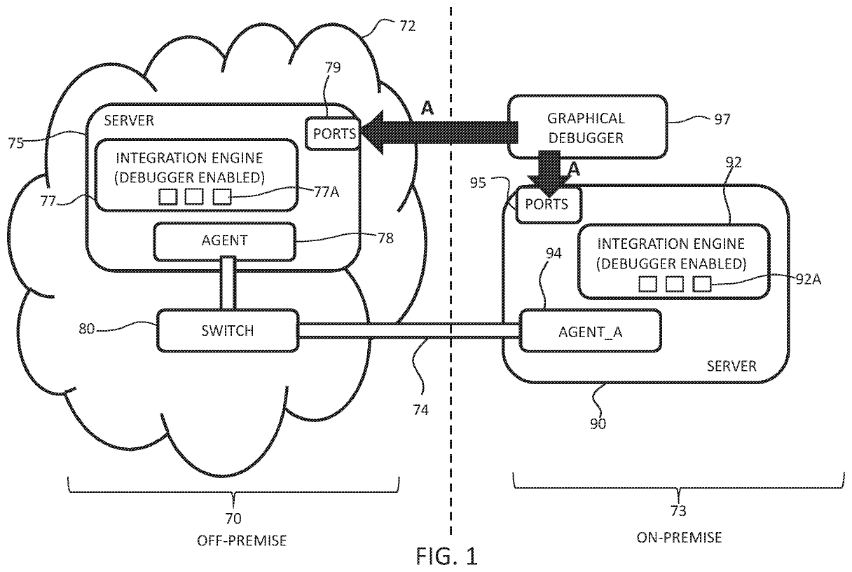

To aid understanding of the proposed concept(s), a conventional approach to debugging a hybrid cloud system, in accordance with an embodiment of the present invention, will now be described with reference to FIG. 1. Here, a hybrid cloud system comprises off-premise resources 70 in the cloud 72 which are accessible to on-premise resources 73 via an Internet communication link 74.

The off-premise resources 70 comprise an off-premise server 75. The off-premise server 75 is a cloud-based server 75 and comprises an integration engine 77 (running one or more integration parts 77A), a server module/agent 78, and network ports 79 (exposed by the off-premise server 75). Here, it is noted the network ports 79 will be exposed to the public internet and so any communications via these ports 79 may need to be secured (e.g. using HTTPS).

The off-premise resources 70 also comprise a switching component (i.e. connectivity component) 80 adapted to manage communication between the off-premise server 75 and the on-premise resources 73. The switching/connectivity component 80 allows agents to connect from servers and send and receive requests from other integrations.

The on-premise resources 73 may comprise on-premises systems or private clouds.

The on-premise resources comprise an on-premise server 90. The on-premise server is a local server 90 that is run and maintained by a user directly. Here, it is noted that the local server 90 can also be run in its own private cloud. The on-premise server 90 comprises an integration engine 92 (running one or more integration parts 92A), a secure server module/agent 94, and network ports 95 (exposed by the on-premise server 90). The integration engine 92 is configured to run part of an integration. It can call other integrations within the local server 90 or it can call integrations running in remote servers like the off-premise server 75 (using the secure server module/agent 94).

The network ports 95 exposed by the local server 90 include: HTTP/TCPIP server ports for calling integrations; a HTTP server port for administration; and a JVM debug port for debugging integrations in the integration engine. These ports can be secured with TLS and mutual authentication certificates.

The on-premise resources 73 also comprise a graphical debugger 97. The graphical debugger 97 connects to JVM debug ports exposed from a server when debugging is enabled. Thus, to debug an integration in the off-premise server 75, the JVM port 79 of the cloud-based server 75 must be exposed so that the debugger 97 has access to it. This requires both location details and security information (such as certificates).

In this conventional hybrid cloud system, debugging is exposed to all servers by exposing the JVM debug port on all servers so they are directly accessible to the graphical debugger 97. Thus, the graphical debugger 97 accesses the JVM debug port of the off-premise server 75 and the on-premise server 90 as indicated by the arrows labeled “A”. This is difficult because it requires securing the off-premise ports 79 using mutual authentication and so requires a complex setup in order to keep debugging communications secure. It also quickly becomes unmanageable once the system is expanded to include numerous servers both off-premise 70 (e.g. in the cloud 72) and on-premise 73.

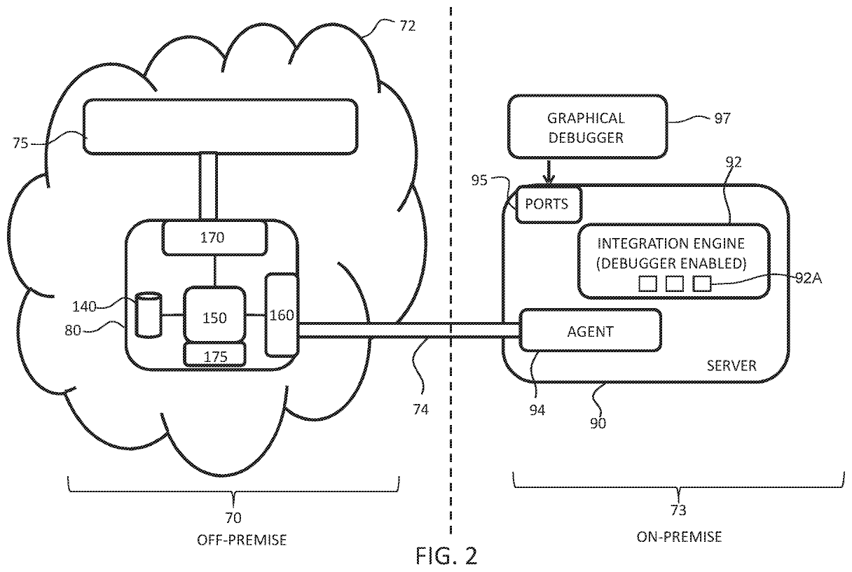

Proposed concepts address such problems by taking a different approach to debugging and leveraging secure connectivity that is available to allow integrations to call each other independently of where they are located. To aid understanding of the such proposed concepts, an exemplary embodiment for managing debugging across off-premise and on-premise several will now be described with reference to FIG. 2.

FIG. 2 shows a modified version of the system of FIG. 1, wherein there are some fundamental changes. In particular, the network ports component in the off-premise server 75 is no longer required in order to expose the off-premise server 75 to the graphical debugger 97. Instead, it is proposed to implement a port forwarding capability in the switching/connectivity component 80 in order to expose a debug port via the on-premise server 90. In this way, the graphical debugger 97 can establish and maintain a forwarded connection to the on-premise server 90, thus effectively enabling the debugging of all servers in the system at the same time. For example, integrations can be moved between servers or from on-premises to off-premise (e.g. the cloud 72) or vice versa with no changes needed to the debugger. The graphical debugger 97 will still connect to the local, on-premise server 90, yet will be able to debug all other servers in debug mode. This may include tracing the flow of a message from one integration to the next, even when they are in separate locations.

Referring now to FIG. 2, the connectivity component 80 is shown in more detail.

The connectivity component 80 comprises: a data store 140; a routing component 150; a first communication component 160; and a second communication component 170. The data store 140 comprises a debug port data store adapted to store debug port data associated with debug ports that are provided by the off-premise resources 70. By way of example, the debug port data may comprise information relating to port identifiers, port protocols, server identifications, server addresses, application version identifiers, permission information, authentication information, and checksum information. The debug port data may be provided to the data store 140 by servers or applications when they are made available by the off-premise resources 70. For this purpose, the switching component 80 comprises a registration module 175 that is adapted to receive debug port data from at least one of: an application of an off-premise server; an application of an on-premise server; an off-premise server module; and an on-premise server module. The registration module 175 may be adapted to store received debug port data in the data store 140, thus enabling the concept of registering information with the connectivity component 80 so that it may identify how to handle (e.g. where to communicate) a debug request. Also, the registration module 175 may be adapted to remove information from the data store 140 in response to an application, a server, a debug port and/or an application becoming inaccessible (e.g. being disconnected, terminated, or powered-down). A registering server or application may therefore register information to identify an application that it provides. This registered information can then be used to match a debug request for an application to a debug port of a server running the required application (e.g. integration).

Put another way, the data store 140 may be adapted to be dynamically updated or maintained in order to reflect changes in available applications or resources.

The data store 140 may therefore be thought of as providing a dynamically updated store of debug port information representing debug port that may be accessible. In this way, the connectivity component 80 may adapt to implementation specifics and cater for changes in available resources (e.g. applications, services and/or debug ports), for example for the registration/deregistration of debug port data to/from the data store 140.

The first communication component 160 is adapted to receive a debug request from the on-premise server 90 (via the agent 94). For this purpose, the first communication component 160 is adapted to establish a secure tunnel for receiving the debug request.

A debug request is a request to access or invoke a debug port provided by the off-premise resources 70. By way of example, a debug request of this embodiment comprises an identification portion and a payload portion. The identification portion includes information relating to the identification of an application (such as an application name for example) or server (such as a server identifier or address for example). The payload portion comprises a data payload (such as a file location information (e.g. directory or path), a debug operation or instruction (e.g. read, write, delete, append, purge, edit, etc.) and data for use in/by the application or server for example).

Upon receiving a debug request, the first communication component 160 passes the received request to the routing component 150. The routing component 150 is adapted to process the received request in conjunction with data stored in the data store 140 in order to identify a requested debug port of an off-premise server. By way of example, the routing component 150 is adapted to analyze the identification portion of the received debug request to identify the requested application or server (for example, based on an identifier included in the identification portion). Further, based on the identified requested application/server, the routing component 150 is then adapted to query the data store 140 to identify debug port data that is associated with the identified requested application/server.

The routing component 150 passes the received debug request to the second communication component 170 along with the identified debug port data associated with the identified requested application/server. The second communication component 170 is adapted to communicate the received debug request to the off-premise resources 70 based on the identified debug port data associated with the identified requested application/server. For this purpose, the second communication component 170 is adapted to establish a secure tunnel for communicating the debug request. For example, the second communication component 170 may establish a mutually authenticated TLS tunnel connection between the connectivity component 80 and the off-premise agent 78.

In this way, the debug request is communicated over a port-forwarded connection to the off-premise server 75. The connection is then maintained and used to communicate information between the off-premise server 75 and the graphical debugger 97 while an application of the off-premise server 75 is being debugged.

Thus, from the description above, the connectivity component 80 may be thought of as having first and second secure components for establishing tunnels with off-premise and on-premise server modules, respectively. The connectivity component 80 may also be thought of as including a registration component that is adapted to register and store (in a data store of the connectivity component 80) debug port data (e.g., port identifiers, server IDs, server addresses, application version identifiers, supported applications, permitted applications, permission information, non-sensitive or public authentication information and checksum information) associated with applications or servers. Applications or servers may therefore register information with the connectivity component 80 when they connect and/or when a configuration changes. Such information may also be deregistered (e.g. removed or deleted from the data store) when an application, server or debug port becomes inaccessible (e.g. is disconnected, powered down or otherwise unavailable). Received calls (e.g. requests) to debug an off-premise resource may thus be analyzed by the connectivity component 80 and be used to query the dynamically maintained data store to identify debug port data indicative of where to communicate the debug event.

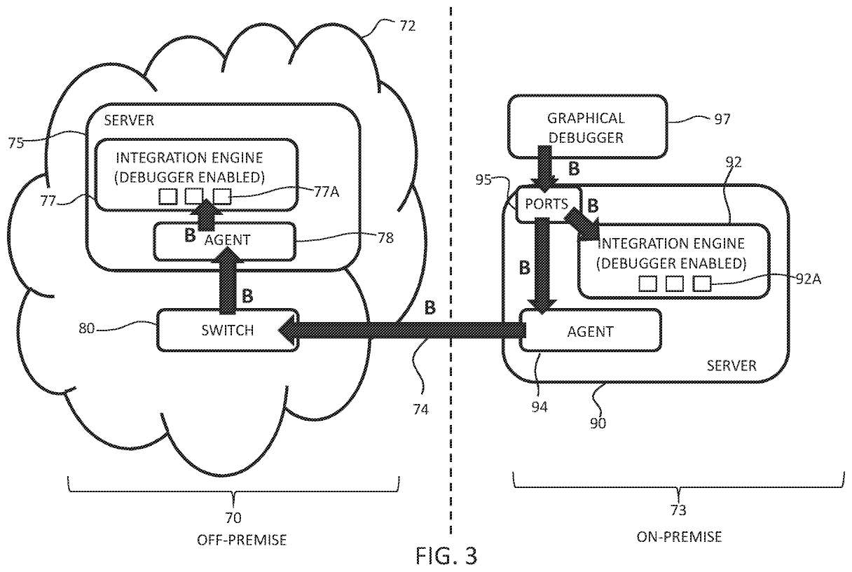

By way of example, and with reference to FIG. 3, an example of an on-premise graphical debugger 97 debugging integrations 92A of the on-premise server 90 and integrations 77A of the off-premise server 75 of FIG. 1 will now be described.

As indicated by the arrows labeled “B”, the graphical debugger 97 of the first server 75 communicates with the integration engine of the on-premise server 90. The graphical debugger also communicates, via agent 94 of the on-premise server 90 and via the connectivity component 80 with the integration engine of the off-premise server 75. This communication is established using: a first secure tunnel between the agent 94 of the on-premise server 90 and the first communication component 160 of the connectivity component 80; and a second secure tunnel between the second communication component 170 of the connectivity component 80 and the agent 78 of the off-premise server 75.

Here, the connectivity component 80 determines a debug port based on the received debug port request from the graphical debugger 97. Based on the determined debug, the second communication component 170 communicates the debug request to the identified debug port of the off-premise server 75.

Further, embodiments may also be adapted to enable the communication of a response to the debug request from the off-premise server 75. By way of illustration, in the example depicted in FIG. 3, the second communication component 170 may be adapted to receive a response to the communicated debug request from the off-premise server. The routing component 150 may then determine the intended destination of the response (e.g. based on analysis of the response and/or stored data relating to previously communicated debug requests) and then pass the response to the first communication component 160 for communication to the originator of the debug request (via the on-premise server). In this way, a response to a debug request/call may be communicated back to the graphical debugger 97 that originated the debug request/call. Proposed embodiments may therefore provide for the management of debugging communication between off-premise and on-premise platforms so that debug requests and responses are securely delivered via a connectivity component (thus avoiding exposure via a public network for example). Put another way, the connectivity component 80 enables a port-forwarded connection to be established between the off-premise server 75 and the on-premise server 90. The connection can then remain open while an application of the off-premise server 75 is being debugged.

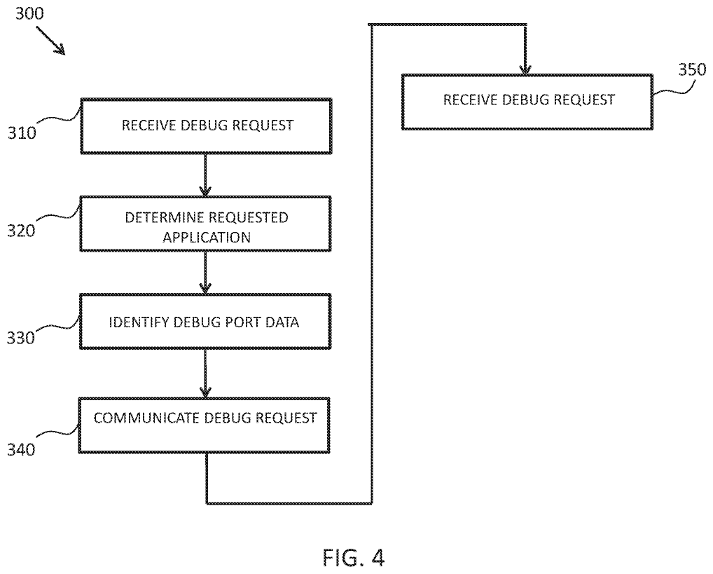

Referring now to FIG. 4, there is depicted a flow diagram of a method 300 for managing debugging across off-premise and on-premise servers according to an embodiment. The method 300 of FIG. 4 is described as being implemented with a connectivity component (e.g. switching module) according to a proposed embodiment.

The method 300 begins with the step 310 within which a debug request is received by the connectivity component from an on-premise server. Here, the application request is received via a (previously) established secure tunnel. Also, the application request of this example may comprise a request to debug an application which comprises a header or identification portion and a payload portion. The header/identification portion may include information relating to the identification of the requested application (such as an application name for example), and the payload portion may comprise a data payload (such as data for use in debugging the application for example). The debug request may therefore comprise information relating to the application, an event (e.g. read, write, delete, append, purge, edit, etc.) to be completed by the application, an account or user requesting the event, data to be processed by the application, and/or and entry point in the application that the request would be made to. Inclusion of entry point data (such as path identification information, for example) in an application request may enable specification of an entry point in application that the debug request is made to. For example, an application called “application1” could have two entry points called “entry1” and “entry2”. The application request may then include the application name and the entry point within the application, such as “application1/path1” for example. If no entry point information is employed, a default entry point (e.g. start of application code) may be used.

Next, in step 320, the received debug request is processed in conjunction with data stored in a data store of the connectivity component in order to determine a requested application. For example, the connectivity component analyzes the identification portion of the received application request to identify the requested application (for example, based on an application name included in the identification portion). The method then proceeds to step 330, wherein, based on the identified requested application, the connectivity component queries the data store to identify debug port data that is associated with the identified requested application. In other words, based on the identified requested application, the connectivity component searches the data store to find a debug port for the requested application and then extracts debug port data that is stored in the data entry/record for the requested application.

In step 340, the connectivity component then communicates the debug request to an off-premise resource based on the identified debug port data. For this purpose, an established secure tunnel is used to communicate the debug request to a component of the off-premise resource (via the debug port).

In step 350, the debug request is received by the component of the off-premise resource.

Thus, from the above description of the method of FIG. 4, it will be appreciated that a method of receiving a debug request and then communicating (e.g. forwarding) the modified request to an appropriate debug port. It should also be appreciated that the debug request, may or may not require a response to be provided (for example, back to the originator of the request).

Purely by way of further example, a possible approach to implementing the proposed concept(s) in a hybrid cloud system may comprise the following steps: (i) go to all integration servers wanted to be in debug mode and turn on (i.e. activate or enable) debugging; (ii) download a configuration file from the connectivity component and run a command that sets up a local (i.e. on-premise) integration server to expose all debug ports of the remote (i.e. off-premise) servers; and (iii) start the debugger pointing at all the local (i.e. on-premise) debug ports.

Modifications to this above approach may become even more streamlined with the graphical debugger automatically pulling down the configuration file and doing the setup phase for a user followed by automatically connecting to all local ports.

Embodiments described above have only included two integration servers: one off-premise and one on-premise. However, it will be appreciated that the proposed concept may be scaled to multiple integration servers both off-premise and on-premise. Also, the integration servers of the on-premise systems do not even have to be on the same network.

Proposed embodiments, such as those presented above with reference to their figures, may provide the benefit of enabling a debugging user to step through an off-premise resource (via an on-premise integration) as if it is running locally (i.e. in the on-premise resource(s) of the user). The user experience may thus be that he/she is debugging a local integration server although they are in fact debugging all enabled servers. This may allow for debugging integrations that comprise flows in more than one integration server and that are not collocated.

Further, proposed embodiments may also reduce an amount of private or sensitive debugging information (such as authentication information or security credentials) that passes between application in off-premise and on-premise platforms via a public network.

As will be apparent from the above description, an off-premise resource may be provided by a cloud-computing system. Also, a connectivity component or method for managing debugging communication between off-premise and on-premise platforms may be provided or implemented in a hybrid cloud-computing system.

With reference to the following description made with regard to a cloud computing system, it is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed. The following description of a cloud computing system and environment is made purely for the purposes of explanation and understanding.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This off-premise cloud model may include at least five characteristics, at least three service models, and at least four deployment models.

Characteristics are as follows:

On-demand self-service: a cloud consumer can unilaterally provide computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems; storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises. Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds). A cloud computing environment is service oriented with a focus on statelessness, low coupling, modularity, and semantic interoperability. At the heart of cloud computing is an infrastructure comprising a network of interconnected nodes.

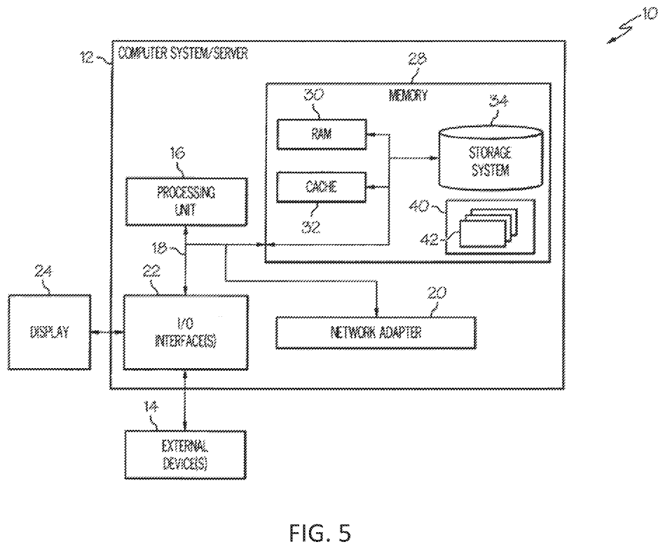

Referring now to FIG. 5, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

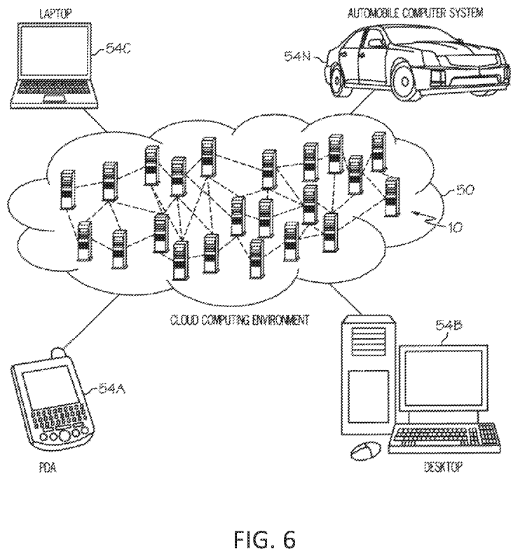

Referring now to FIG. 6, illustrative cloud computing environment or cloud computing system 50 is depicted. This can, in embodiments, be equated to the cloud computing system as depicted in FIG. 1A for example. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

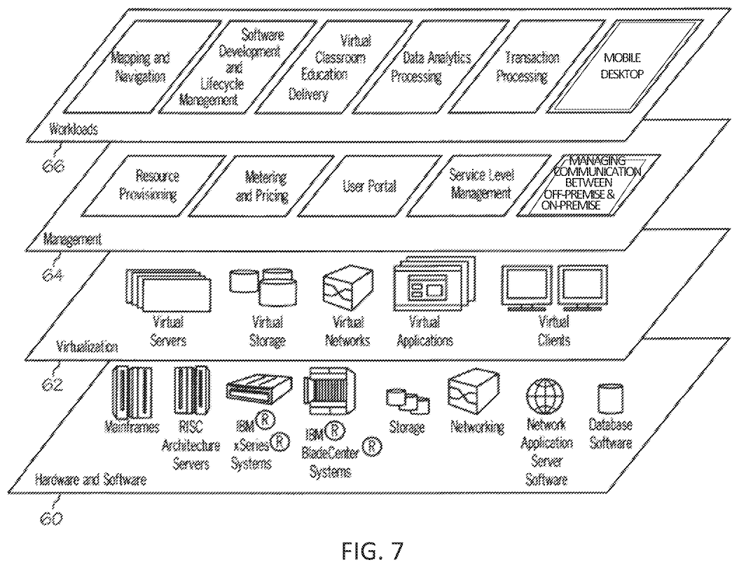

Referring now to FIG. 7, a set of functional abstraction layers provided by cloud computing environment 50 (FIG. 6) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Managing debugging across off-premise and on-premise platforms provides for managing debugging according to proposed concepts as detailed above.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and mobile desktop.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a storage class memory (SCM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for managing debugging across off-premise and on-premise servers, the method comprising:
receiving, via a first communication component of a connectivity component, a debug request from an on-premise server;
identifying, by the connectivity component, a debug port of an off-premise server based, at least in part, on the received debug port request; and
communicating, via a second communication component of the connectivity component, the debug request to the identified debug port of the off-premise server.

2. The computer-implemented method of claim 1, wherein:
receiving the debug request from the on-premise server includes establishing a secure tunnel for receiving the debug request; and
communicating the debug request to the identified debug port of the off-premise server includes establishing a secure tunnel for communicating the debug request.

3. The computer-implemented method of claim 1, further comprising:
receiving debug port data relating to the debug port; and
storing the received debug port data in a data store.

4. The computer-implemented method of claim 3, wherein the debug port data is received from a source selected from the group consisting of: an on-premise server application, an off-premise server application, an on-premise server module, and an off-premise server module.

5. The computer-implemented method of claim 3, further comprising:
removing the debug port data from the data store in response to an element becoming inaccessible.

6. The computer-implemented method of claim 5, wherein the element is selected from the group consisting of: an application, a server, and the debug port.

7. The computer-implemented method of claim 1, further comprising:
receiving, via the second communication component of the connectivity component, from the off-premise server, a response to the debug request; and
communicating, via the first communication component of the connectivity component, to the on-premise server, the received response.

8. A computer program product for managing debugging across off-premise and on-premise servers, the computer program product comprising a computer readable storage medium having program instructions embodied therewith, the program instructions executable by a processing unit to cause the processing unit to perform a method comprising:
receiving, via a first communication component of a connectivity component, a debug request from an on-premise server;
identifying, by the connectivity component, a debug port of an off-premise server based, at least in part, on the received debug port request; and
communicating, via a second communication component of the connectivity component, the debug request to the identified debug port of the off-premise server.

9. The computer program product of claim 8, wherein:
receiving the debug request from the on-premise server includes establishing a secure tunnel for receiving the debug request; and
communicating the debug request to the identified debug port of the off-premise server includes establishing a secure tunnel for communicating the debug request.

10. The computer program product of claim 8, the method further comprising:
receiving debug port data relating to the debug port; and
storing the received debug port data in a data store.

11. The computer program product of claim 10, wherein the debug port data is received from a source selected from the group consisting of: an on-premise server application, an off-premise server application, an on-premise server module, and an off-premise server module.

12. The computer program product of claim 10, the method further comprising:
removing the debug port data from the data store in response to an element becoming inaccessible.

13. The computer program product of claim 12, wherein the element is selected from the group consisting of: an application, a server, and the debug port.

14. The computer program product of claim 8, the method further comprising:
receiving, via the second communication component of the connectivity component, from the off-premise server, a response to the debug request; and
communicating, via the first communication component of the connectivity component, to the on-premise server, the received response.

15. A computer system for managing debugging across off-premise and on-premise servers, the computer system comprising:
a processing unit; and
a computer readable storage medium;
wherein:
the computer readable storage medium includes program instructions embodied therewith; and
the program instructions are executable by the processing unit to cause the processing unit to perform a method comprising:
receiving, via a first communication component of a connectivity component, a debug request from an on-premise server;
identifying, by the connectivity component, a debug port of an off-premise server based, at least in part, on the received debug port request; and
communicating, via a second communication component of the connectivity component, the debug request to the identified debug port of the off-premise server.

16. The computer system of claim 15, wherein:
receiving the debug request from the on-premise server includes establishing a secure tunnel for receiving the debug request; and
communicating the debug request to the identified debug port of the off-premise server includes establishing a secure tunnel for communicating the debug request.

17. The computer system of claim 15, the method further comprising:
receiving debug port data relating to the debug port; and
storing the received debug port data in a data store.

18. The computer system of claim 17, wherein the debug port data is received from a source selected from the group consisting of: an on-premise server application, an off-premise server application, an on-premise server module, and an off-premise server module.

19. The computer system of claim 17, the method further comprising:
removing the debug port data from the data store in response to an element becoming inaccessible.

20. The computer system of claim 15, the method further comprising:
receiving, via the second communication component of the connectivity component, from the off-premise server, a response to the debug request; and
communicating, via the first communication component of the connectivity component, to the on-premise server, the received response.
